(19) United States
(12) Patent Application Publication
(10) Pub. No.: US 2006/0092038 A1
(43) Pub. Date: May 4, 2006

(54) Chameleon button universal remote control with tactile feel

(76) Inventor: Robert Allan Unger, El Cajon, CA (US)

Correspondence Address: ROGITZ & ASSOCIATES, 750 B STREET, SUITE 3120, SAN DIEGO, CA, 92101, US

(21) Appl. No.: 11/214,177

(22) Filed: Aug. 29, 2005

Related U.S. Application Data
(60) Provisional application No. 60/624,940, filed on Nov. 3, 2004.

(51) Int. Cl. H04B 1/20

(52) U.S. Cl. 340/825.25; 340/825.69; 341/176; 348/734; 340/3.71

(57) ABSTRACT

A remote control device has A/V component select buttons corresponding to respective A/V components, and one or more depressible multifunction buttons each serving multiple functions. The particular function depends on which component select button was last depressed and/or on an operational state of the selected component. The multifunction button includes a matrix of illuminable elements that can be energized as appropriate to display a word, a phrase, or a symbol.

This application claims priority from U.S. provisional patent application Ser. No. 60/624,940, filed Nov. 3, 2004.

### I. FIELD OF THE INVENTION

The present invention relates generally to remote control devices for audio-video (A/V) systems.

### II. BACKGROUND OF THE INVENTION

Remote controls proliferate with each new piece of consumer electronics added to a household. While some remotes can control some features on equipment other than the one they came with, there is always something that requires the original remote. This leads to a clutter of individual remotes.

Some commands such as volume, play, pause, stop, etc. have the same logical function on multiple pieces of equipment. Conventional universal remotes can take advantage of this by using the same button for all devices. This is not possible for all functions, however. Unique buttons require generic labels such as “Aux”. Some present remotes replace the hard button remote with a LCD screen remote, but this has two drawbacks. First, users are burdened by a cluttered remote with too many buttons. And, users prefer the tactile feel of a conventional remote control button that reciprocates up and down.

### SUMMARY OF THE INVENTION

A remote control device includes plural component select buttons corresponding to respective A/V components that are controllable by the remote control device, and at least one multifunction button to serve multiple functions, with the particular function depending on which component select button was last depressed and/or on an operational state of the selected component. The multifunction button includes a matrix of illuminable elements with a predetermined subset only of the elements of the multifunction button being illuminated based on the selected component and/or its operational state to indicate a word, a phrase, or a symbol. The multifunction button is depressible by a user to move the button down, and the button moves back up when released.

In non-limiting embodiments the component select buttons include a TV select button and at least one of: a digital video disk (DVD) select button, a personal video recorder (PVR) select button, or a video cassette recorder (VCR) select button. A central processing unit (CPU) such as a microcontroller may be in the remote control device for controlling the matrix, and the illuminable elements can be light emitting diodes (LEDs) or liquid crystal display elements (LCDs) or other type of element.

In non-limiting implementations discussed below, the CPU can cause a first symbol to be displayed on the multifunction button corresponding to a first command when a selected component is in a first operational state and a second symbol to be displayed on the multifunction button corresponding to a second command when a selected component is in a second operational state. In other non-limiting implementations, when a selected component is a first component, the CPU may cause a first word to be displayed on the multifunction button, with the first word corresponding to a first command. When the selected component is a second component, however, the CPU may cause a second word to be displayed on the multifunction button, with the second word corresponding to a second command.

If desired, the multifunction button can be established by a circuit board and a flexible substrate materially biased so that a portion of the substrate is distanced from the circuit board when a user is not pushing down on the button and so that a user can tactilely depress the multifunction button until the portion contacts the circuit board to thereby generate an input signal. A molding may be positioned around the matrix of illuminable elements to establish shape (“feel”) for the button.

In another aspect, a system includes plural A/V components and a remote control device in wireless communication with at least one of the components. Means are provided on the remote control device for selecting one of the A/V components. Also, at least one multifunction button is on the remote control device and reciprocates up and down when a user presses and releases it. The button has a first display and a corresponding first function when a first A/V component is selected and a second display and a corresponding second function when a second A/V component is selected by a user. Or, the button has a first display and a first function when a selected A/V component is in a first operational state and a second display and second function when the selected A/V component is in a second operational state. The button is separated from other buttons on the remote control device by respective immobile, substantially rigid facia elements.

In yet another aspect, a system for controlling plural A/V components includes wireless communication means for sending commands to the components, means for generating a component select command using one of plural discrete component select buttons, and means for generating a display on a discrete multifunction button based at least in part on the generation of the component select command.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a top plan view of the present remote control device, schematically showing various words that can be displayed on a multi-function button;

FIG. 2 is a side view of a first embodiment of a multi-function button;

FIG. 3 is a side view of a second embodiment of a multi-function button;

FIG. 4 is a block diagram of a first system with which the present remote control device may be used; and

FIG. 5 is a block diagram of a second system with which the present remote control device may be used.

### DETAILED DESCRIPTION OF THE PREFERRED EMBODIMENT

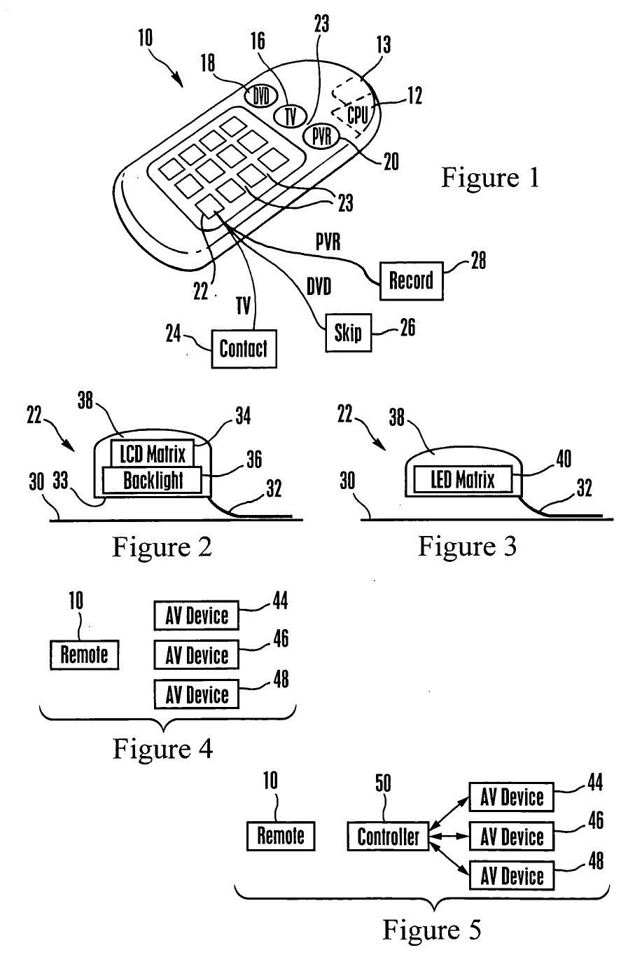

Referring initially to FIG. 1, a nonspecific universal remote is generally labeled 10. A CPU 12 is shown to be internally located in the remote 10, and the CPU 12 controls a wireless transmitter 13 such as but not limited to an IR transmitter.

Since the remote 10 may be used to input commands into multiple pieces of equipment, component select buttons corresponding to respective pieces of equipment are provided. For instance, FIG. 1 shows a TV select button 16, a DVD select button 18, and a select PVR button 20, keeping in mind these corresponding pieces of equipment are not limiting to the invention. For instance, a VCR select button may also be provided.

Also, one or more multifunction buttons 22 are provided on the remote 10 to serve multiple functions, with the particular function depending on which component select button was last depressed and/or on the operational state of the selected component. As set forth further below, each multifunction button 22 includes a matrix of illuminable elements, such as LCDs or LEDs, with a predetermined subset only of the elements of a button 22 being illuminated by the CPU 12 based on the selected component and/or its operational state to indicate a word, a phrase, or a symbol.

The multifunction buttons 22, like the component select button 16-20, are depressible buttons, i.e., a user moves a button down and up and can tactilely feel the button move as the user would feel a button on a conventional remote control move when depressed and released. The buttons 16-22 are separated from each other, i.e., unlike a touch pad or touch screen, non-depressible, substantially rigid and immobile plastic facia elements 23 can be on the surface of the plastic remote control housing as shown between adjacent buttons 16-22. Thus, the present buttons are discrete from each other, being separated by facia elements like buttons on a conventional remote and unlike input elements of a touch pad.

To illustrate by non-limiting example, if the TV select button 16 was depressed, the CPU 12 illuminates a subset of elements on the multifunction button 22 to indicate the word Acontrast@, indicated at 24. If a user depresses the multifunction button 22 under these conditions, the CPU will interpret this as an input of a contrast command to the TV. On the other hand, if the DVD select button 18 is depressed, the CPU 12 may illuminate a subset of the elements on the multifunction button 22 to indicate the word Askip@ at 26, with subsequent manipulation of the button 22 being interpreted by the CPU 12 as a skip command for the DVD. Likewise for a selection of the PVR select button 20, the multifunction button 22 can be made to indicate the word Arecord@ at 28, with subsequent manipulations of the button 22 being interpreted as record commands to the PVR.

Additionally, as mentioned above the display of a multifunction button 22 may depend on the operational state of a component. Thus, for instance, if the DVD select button 18 is manipulated with the DVD initially in a paused state, a subset of the matrix elements of a multifunction button 22 may be illuminated by the CPU 12 to indicate the Aplay@ symbol, e.g., the symbol A>A. If the button is manipulated to cause the DVD to enter the play state, the CPU 12 can illuminate a subset of the matrix elements of the button to indicate the Apause@ symbol, e.g., two vertical lines. This is but one non-limiting example of how the matrix elements of a multifunction button 22 may be controlled to indicate a symbol or word based on the operational state of a controlled component.

Moving in reference to FIG. 2, a profile view of a non-limiting multifunction button 22 is shown. A main circuit board 30 can be mounted in the housing of the remote control device, and a flexible substrate 32 is engaged with the main board 30. The substrate 32 is materially biased so that a portion 33 is distanced from the main board 30 when a user is not pushing down on the button. A two dimensional LCD matrix 34 having rows and columns of illuminable elements, along with an appropriate backlight element 36, are mounted to the flexible substrate 32. A rubber molding 38 is placed around the matrix 34 to add shape to the button. With the structure shown in FIG. 2, it will readily be appreciated that a user tactilely depresses the button 22 until the substrate portion 33 contacts the main board 30 to thereby generate an input signal to the CPU 12, indicating that the button 22 has been pushed and giving the user the same tactile experience as when manipulating a conventional remote control button. When the user releases the button 22, the portion 33 moves back to the position shown in FIG. 2.

FIG. 3 shows that instead of an LCD matrix with backlight element, the present multifunction button 22 may have an LED matrix 40, with all other components of the button shown in FIG. 3 being identical to those shown in FIG. 2. Other illuminable elements may be used.

FIG. 4 shows a system which includes the present remote control device 10 controlling plural, e.g., three, A/V devices 44, 46, and 48. This method of control is termed uni-directional control because the remote control device 10 sends commands to the A/V device (whichever particular device had been pre-selected) and assumes that the command was received. In contrast, FIG. 5 displays bi-directional control that includes the remote control device 10 and A/V devices 44, 46, and 48, with an addition of a controller 50 communicating with the A/V devices 44, 46, and 48. This type of control provides feedback from the device being controlled through the controller 50 (which has wireless communication capability) to the remote control device 10, to facilitate, e.g., configuring the display of a multifunction button 22 based on the A/V device state.

While the particular CHAMELEON BUTTON UNIVERSAL REMOTE CONTROL WITH TACTILE FEEL as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A remote control device comprising:
plural component select buttons corresponding to respective A/V components controllable by the remote control device; and
at least one multifunction button to serve multiple functions, with the particular function depending on which component select button was last depressed and/or on an operational state of the selected component, the multifunction button including a matrix of illuminable elements with a predetermined subset only of the elements of the multifunction button being illuminated based on the selected component and/or its operational state to indicate a word, a phrase, or a symbol, the multifunction button being depressible by a user to move the button down, the button moving back up when released.

2. The device of claim 1, wherein the component select buttons include a TV select button and at least one of: A DVD select button, a PVR select button, or a VCR select button.

3. The device of claim 2, comprising a CPU in the remote control device and controlling the matrix.

4. The device of claim 3, wherein the illuminable elements include LEDs.

5. The device of claim 3, wherein the illuminable elements include LCDs.

6. The device of claim 3, wherein the CPU causes a first symbol to be displayed on the multifunction button corresponding to a first command when a selected component is in a first operational state and a second symbol to be displayed on the multifunction button corresponding to a second command when a selected component is in a second operational state.

7. The device of claim 3, wherein when a selected component is a first component, the CPU causes a first word to be displayed on the multifunction button, the first word corresponding to a first command, and wherein when the selected component is a second component, the CPU causes a second word to be displayed on the multifunction button, the second word corresponding to a second command.

8. The device of claim 1, wherein the multifunction button is established at least in part by a circuit board and a flexible substrate materially biased so that a portion of the substrate is distanced from the circuit board when a user is not pushing down on the button and so that a user can tactilely depress the multifunction button until the portion contacts the circuit board to thereby generate an input signal.

9. The device of claim 7, comprising a molding positioned around the matrix of illuminable elements to establish shape for the button.

10. The device of claim 1, comprising at least one A/V component in wireless communication with the remote control device.

11. A system, comprising:
plural A/V components;
a remote control device in wireless communication with at least one of the components;
means on the remote control device for selecting one of the A/V components; and
at least one multifunction button on the remote control device reciprocating up and down when a user presses and releases it, the button having a first display and a corresponding first function when a first A/V component is selected, the button having a second display and a corresponding second function when a second A/V component is selected by a user, and/or the button having a first display and a first function when a selected A/V component is in a first operational state and a second display and second function when the selected A/V component is in a second operational state, the button being separated from other buttons on the remote control device by respective immobile, substantially rigid facia elements.

12. The system of claim 11, wherein the means for selecting includes plural component select buttons including a TV select button and at least one of: A DVD select button, a PVR select button, or a VCR select button.

13. The system of claim 11, comprising a CPU in the remote control device and controlling a matrix of illuminable elements for establishing the first and second displays.

14. The system of claim 13, wherein the illuminable elements include LEDs.

15. The system of claim 13, wherein the illuminable elements include LCDs.

16. The system of claim 13, wherein the CPU causes a first symbol to be displayed on the multifunction button corresponding to a first command when a selected component is in a first operational state and a second symbol to be displayed on the multifunction button corresponding to a second command when a selected component is in a second operational state.

17. The system of claim 13, wherein when a selected component is a first component, the CPU causes a first word to be displayed on the multifunction button, the first word corresponding to a first command, and wherein when the selected component is a second component, the CPU causes a second word to be displayed on the multifunction button, the second word corresponding to a second command.

18. The system of claim 11, wherein the multifunction button is established at least in part by a circuit board and a flexible substrate materially biased so that a portion of the substrate is distanced from the circuit board when a user is not pushing down on the button and so that a user can tactilely depress the multifunction button.

19. A system for controlling plural A/V components, comprising:
wireless communication means for sending commands to the components;
means for generating a component select command using one of plural discrete component select buttons; and
means for generating a display on a discrete multifunction button based at least in part on the generation of the component select command.
